(19) United States
(12) Patent Application Publication
(10) Pub. No.: US 2006/0261794 A1
(43) Pub. Date: Nov. 23, 2006

(54) Method & apparatus for DC-DC regulation with improved transient function

(76) Inventor: Marcus W. May, Austin, TX (US)

Correspondence Address: GARLICK HARRISON & MARKISON, P.O. BOX 160727, AUSTIN, TX, 78716-0727, US

(21) Appl. No.: 11/130,883

(22) Filed: May 17, 2005

(51) Int. Cl. G05F 1/00

(52) U.S. Cl. 323/283

(57) ABSTRACT

Provided is a digital DC-DC regulation module. The digital regulation module includes a feedback network, a feedback error module, and a filter module. The feedback network is operably coupled to an output voltage to provide a feedback signal. The feedback error module is operably coupled to compare the feedback signal with a plurality of reference levels to produce a multi-bit error term. The filter module is operably coupled to filter the multi-bit error term to produce a regulation signal. In this manner, the digital DC-DC regulation provides an improved transient function.

### TECHNICAL FIELD

This invention relates generally to power supplies and more particularly to regulating DC output voltages.

### BACKGROUND

As is known, integrated circuits are used in a wide variety of electronic equipment, including portable, or handheld, devices. Such handheld devices include personal digital assistants (PDA), CD players, MP3 players, DVD players, AM/FM radio, a pager, cellular telephones, computer memory extension (commonly referred to as a thumb drive), etc. Each of these handheld devices includes one or more integrated circuits to provide the functionality of the device. For example, a thumb drive may include an integrated circuit for interfacing with a computer (for example, personal computer, laptop, server, workstation, etc.) via one of the ports of the computer (for example, Universal Serial Bus, parallel port, etc.) and at least one other memory integrated circuit (for example, flash memory).

As another example, an MP3 player may include multiple integrated circuits to support the storage and playback of digitally formatted audio (that is, formatted in accordance with the MP3 specification). As is known, one integrated circuit may be used for interfacing with a computer, another integrated circuit for generating a power supply voltage, another for processing the storage and/or playback of the digitally formatted audio data, and still another for rendering the playback of the digitally formatted audio data audible.

As is known, all electronic devices that include integrated circuits require at least one DC voltage supply and typically require multiple DC voltage supplies. A DC voltage supply may be generated from an AC voltage source (for example, 110 volts AC) or from another DC voltage supply (for example, a battery). To generate a DC voltage supply from an AC voltage, the AC voltage is processed in a controlled manner. For example, a switch-mode power supply will rectify the AC voltage to produce a DC bridge voltage. Using one of a plurality of switch mode converter topologies (for example, full bridge, half bridge, buck, or boost) an inductor is charged and discharged at a controlled rate to produce a regulated DC voltage supply.

But devices are increasingly coming into use that have greater power requirements with respect to other electronic device components used in portable or handheld devices. As an example, micro-miniature hard drives having large storage capacities of 30 GBytes are used in portable devices. But for operation, these devices generally have a burst mode where a regulator needs to deliver a relatively large amount of current on short notice. Addressing these increased power requirements can be onerous because they require special circuitry for isolated operations, because they need to have decreased transient response time and assessment to compensate for these power requirements, as well as integration with other components of the integrated circuit.

Therefore, a need exists for a method and apparatus for DC-DC converter regulation having a decreased response time and power compensation to accommodate the power requirements of these devices without the above-referenced limitations.

### SUMMARY

Accordingly, provided is a digital regulation module. The digital regulation module includes a feedback network, a feedback error module, and a filter module. The feedback network is operably coupled to an output voltage to provide a feedback signal. The feedback error module is operably coupled to compare the feedback signal with a plurality of reference levels to produce a multi-bit error term. The filter module is operably coupled to filter the multi-bit error term to produce a regulation signal. In this manner, the digital DC-DC regulation provides an improved transient function.

Another aspect provides the digital regulation module in a DC-DC converter configuration. The DC-DC converter includes the digital regulation module, a quantizer module, and a switching circuit. The quantizer module is operably coupled to quantize the regulation signal to produce at least a charge signal. The switching circuit operably coupled to receive the charge signal, wherein the switching circuit couples an external element to a source for charging in accordance with the charge signal and couples the external element to a load in accordance with the charge signal.

### DESCRIPTION OF THE DRAWINGS

FIG. 1 is a schematic block diagram of a multiple function battery operated system-on-a-chip in accordance with the present invention;

FIG. 2 illustrates a schematic block diagram of a regulation module in accordance with the present invention deployed in a digital DC-DC converter;

FIG. 3 illustrates a schematic block diagram of the feedback error module of FIG. 2;

FIG. 4 illustrates a schematic block diagram of the quantizer of FIG. 2;

FIG. 5 illustrates a schematic block diagram of the feedback error module of FIG. 3;

FIG. 6a is a graph of an error-assess signal with respect to an input voltage differential of a hysteretic comparator of FIG. 5;

FIG. 6b is a graph of a filtered error-assess signal of FIG. 6a; and

FIG. 7 is a graph of a multi-bit error term versus a voltage differential illustrating a linear error estimation function of the regulation module of the present invention.

### DETAILED DESCRIPTION

The embodiments of the present invention may be practiced in a variety of settings that implement a power converter, such as a digitally-controlled linear regulator.

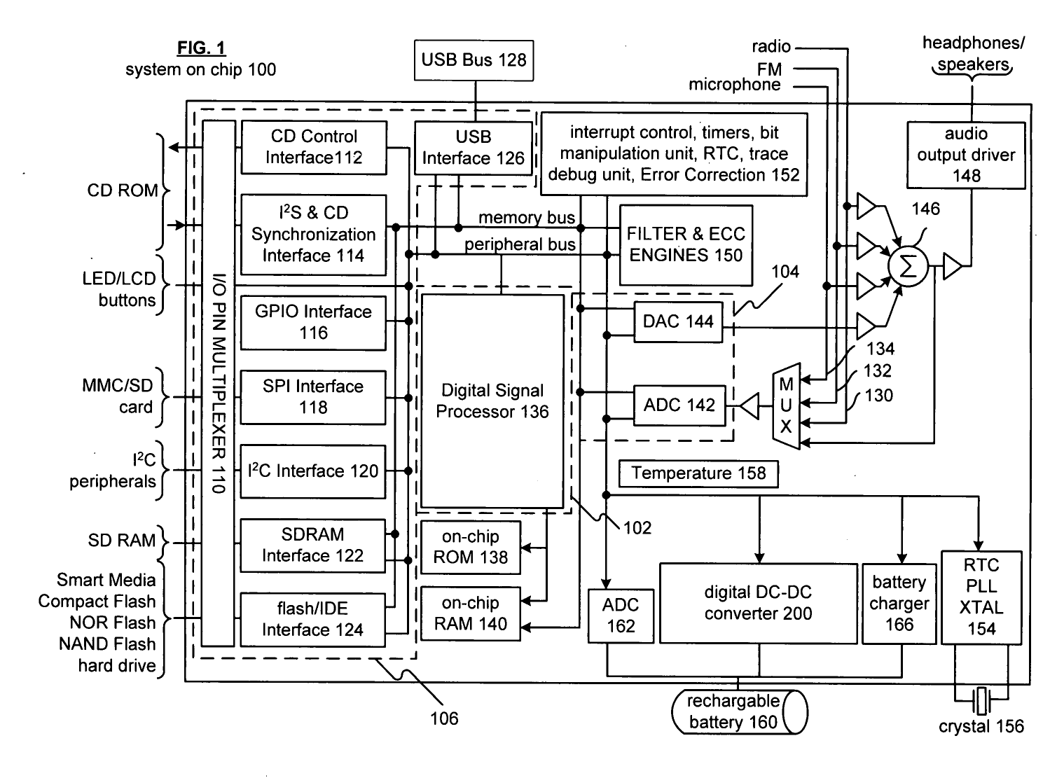

For example, in one embodiment of the invention, a digital DC-DC converter regulation module receives power and regulates the voltage to an output voltage, which is utilized by other component(s) powered by the DC-DC converter regulation module. When external power (such as power provided by a Universal Serial Bus interconnection), the DC-DC converter regulation module may regulate this power source as well with respect to providing voltage and current demands of the system. With that understanding, the examples below are described in reference to regulating a battery source to a specified DC power source, which powers a load. Furthermore, although a variety of different systems and components may be implemented, a particular system implementation is illustrated in FIG. 1 as one embodiment of a system to practice the invention.

Referring to FIG. 1, an example integrated circuit (IC) 100 is shown in which one embodiment of the invention is implemented within IC 100. The example IC 100 is a single IC chip that implements a multiple function system-on-a-chip. It is to be noted that the example embodiment of FIG. 1 implements a complete media system on a single chip, but other embodiments of the invention may incorporate one or more integrated circuit chips to provide a complete system or parts of a system.

As illustrated in FIG. 1, a variety of blocks are noted within the IC 100. The various blocks exemplify hardware components, software and interfaces resident within the IC 100. The example media system of the IC 100 may operate with one or a variety of devices, as illustrated in FIG. 1.

Accordingly, a CD (compact disc); LED (Light Emitting Diode)/LCD (Liquid Crystal Display) displays, buttons and/or switches; MMC (Multimedia Card)/SD (Secure Digital) cards; I²C (Inter-Integrated Circuit) peripherals; SmartMedia, Compact Flash, NOR Flash, NAND Flash, and/or hard drive devices; and memory, such as SDRAM (Synchronous Dynamic Random Access Memory) are some components that may be operably coupled to the IC 100 through the digital interface circuitry 106 is provided by an I/O (input/output) pin multiplexer 110, as illustrated in FIG. 1. These various multiplexed connections are coupled to respective interfaces, as shown in FIG. 1. These interfaces include CD control interface 112; I2S (Inter-IC sound) and CD synchronization interface 114; GPIO (General Purpose Input/Output) interface 116, SPI (Serial Peripheral Interface) interface 118; I2C interface 120; SDRAM interface 122 and Flash/IDE (Integrated Device Electronics) interface 124.

Furthermore, the digital interface circuitry 106 provides a Universal Serial Bus (“USB”) interface 126 for the coupling of a USB connection external to IC 100. The USB interface 126 provides compatibility with USB 2.0 specification, and is backwards compatible to a USB 1.1 specification. As should be readily appreciated, the USB interface 126 may be provided for interfacing with additional USB specifications or similar communications protocols as they become available. A microphone input, radio input and a line input are also available on IC 100 via the LINE IN 130, FM IN 132, and MIC IN 134 ports to allow interconnection to a microphone, radio, or other audio input.

The processing core 102 of the IC 100 is a DSP (Digital Signal Processor) 136 may be provided as a 24-bit Digital Signal Processor. An on-chip ROM (Read Only Memory) 138 and an on-chip RAM (Random Access Memory) 140 operate as memory for DSP 136. The processing core 102 may also provided by microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Data stored in the ROM 138 and RAM 140, which may have 64 Mbytes or greater of storage capacity, may be text files, presentation files, user profile information for access to varies computer services (for example, Internet access, email, etc.), digital audio files (for example, MP3 files, WMA—Windows Media Architecture, MP3 PRO, Ogg Vorbis, AAC—Advanced Audio Coding), digital video files—for example, still images or motion video such as MPEG (motion picture expert group) files, JPEG (joint photographic expert group) files, etc.—address book information, and/or any other type of information that may be stored in a digital format.

The mixed signal circuitry 104 is provided as an analog-to-digital converter (ADC) 142 and a digital-to-analog converter (“DAC”) 144. The ADC 142 allows for analog inputs to be converted to digital format for processing by DSP 136. Similarly, the (DAC) 144 is present to convert digital signals to analog signals for output in analog form. In this instance, amplified signals through a summing module 146 and audio output driver 148 generate an amplified analog signal output external to IC 100. For example, the analog output may be operably coupled to a set of headphones or speakers.

Also included within the IC 100 is a filter and ECC (Error Correction Circuit) engines 150 to provide filtering and error correction operations. Other functions are shown within block 152 to provide various control and timing functions. These may include Interrupt Control, Timers, Bit Manipulation Unit, Real Time Clock (RTC), Trace Debug Unit, and error correction just to name a few of the operations.

Also within IC 100 is a RTC PLL (Real Time Clock/Phase Lock Loop) circuit 154, which is operably coupled to an external crystal 156 to provide an accurate clocking signal for circuits of the IC 100. Memory and peripheral buses are also present within the IC 100 for transfer of data and signals. A temperature sensor circuit 158 is present to monitor the temperature of IC 100.

In FIG. 1, a rechargeable battery 160 is shown coupled to a lower resolution ADC 162, a DC-DC converter 200, and battery charger 166. The ADC 162 monitors the battery voltage to determine if the battery voltage is such that battery 160 may require charging or if the battery is fully charged. The ADC 162 may also monitor the battery voltage to determine if a battery is present. Thus, if the battery is not present or is removed during use, IC 100 detects the absence of the battery through the monitoring provided by the ADC 162.

The DC-DC converter 200 operates to convert the battery voltage to an operative voltage utilized by the components of the IC 100. Also, the DC-DC converter 200 operates to provide a regulated—that is, a substantially constant and steady—operative voltage level utilized by components of the IC 100. The battery charger 166 is utilized to charge the battery when an external voltage source is coupled to the IC 100.

A variety of batteries may be utilized for battery 160 and, as noted above, battery 160 is a rechargeable battery. In one particular embodiment, the rechargeable battery is a Nickel Metal Hydride (NiMH) battery. Various other batteries may be utilized, including alkaline cells and lithium ion (LiON) batteries. Generally, battery 160 provides a voltage in the range of about 0.9 to about 3.6 volts to IC 100. In the instance where a NiMH battery is used, the typical range is 0.9 to 1.25 volts. Since the voltage from the battery may vary, and/or the circuitry may require voltages other than what is provided by the battery, the digitally-controlled DC-DC converter 200 may provide conversion of the battery voltage to one or more voltages utilized on the IC 100. In some embodiments, the digitally-controlled DC-DC converter 200 may provide more than one DC conversion from the battery. For example, in one embodiment a NiMH battery of 0.9 to 1.25 volts may provide nominal chip voltage of 3.3 volts to the IC 100. In another a combination of 3.3 volts and 1.8 volts are provided to the IC 100.

The IC 100 is designed to also operate from other external power sources, when such power sources are coupled to IC 100. The DC-DC converter 200 operates to regulate such external power sources to provide power to the components of the multiple-function system-on-a-chip of the IC 100.

One of the external power sources may be provided through USB interface 126. Under the USB 2.0 protocol specification, for example, data transfer is specified by the use of differential data lines through a USB link, such as USB bus 128. The data is generally provided on a differential line (“D+” and “D−” lines). The USB 2.0 protocol specification also specifies the presence of a +5 volt DC voltage through bus 126 through V_{BUS} and ground (GND) connections. Thus, an external power source having a voltage of +5 volts (nominal) may be used as a power source for the IC 100 through USB interface 126 when the USB bus 128 is coupled to the IC 100. In this instance, a USB host provides the +5 volts, while IC 100 operates as a USB device coupled to the USB host. The IC 100 then may use the 5 volts to power components or circuitry on the IC 100 provided that the various USB specification requirements are met. Referring to FIG. 1, when USB bus 128 is coupled to the IC 100, the 5 volts from the USB host powers the internal circuitry, instead of battery 160. The battery charger 166 uses the 5 volts from the USB host to also charge battery 160.

Other interface protocols may be implemented, such as Ethernet protocols (such as “Power over Ethernet” under IEEE 802.3 af), Firewire under IEEE 1394, etc. Increasingly, interface specifications are being generated for direct connection of handheld devices such as Personal Digital Assistants (PDAs), cellular phones, MP3 players, and digital cameras to one another without the need for a host PC, in which may provide interface capabilities to the multiple-function system-on-a-chip of the IC 100.

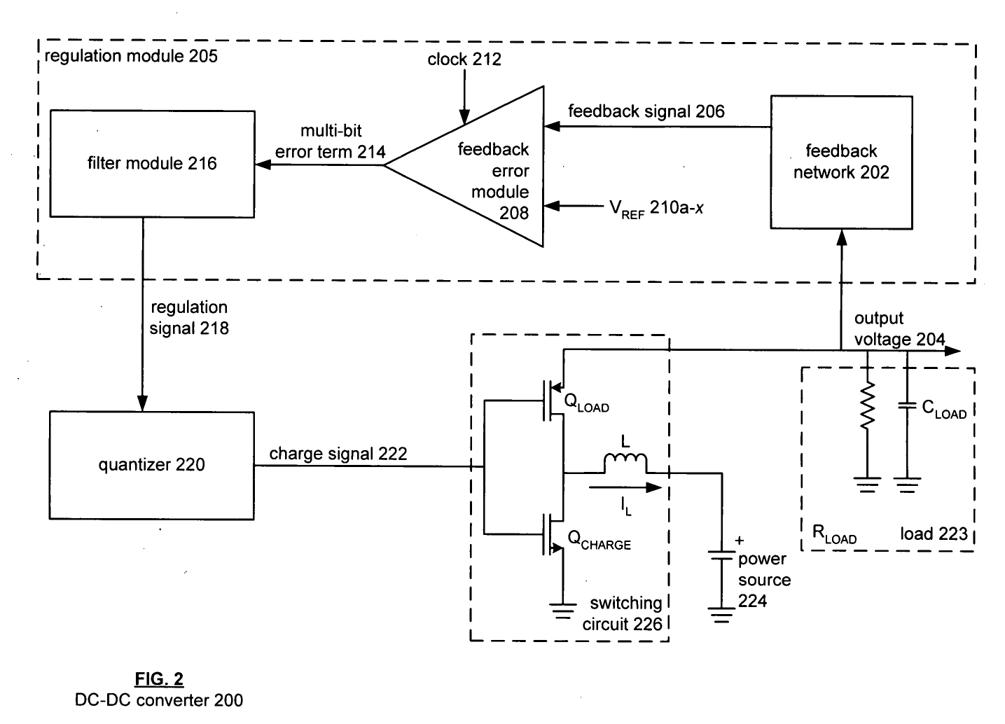

FIG. 2 illustrates a schematic block diagram of a regulation module 205 deployed in a digital DC-DC converter configuration 200 in accordance with the present invention. The configuration for the digital DC-DC converter 200 has a regulation module 205, a quantizer 220, a switching circuit 226, and a load 223. The regulation module 205 has a feedback network 202, a feedback error module 208, and a filter module 216.

The feedback network 202 is operably coupled to an output voltage 204. The feedback network senses the output voltage to provide a feedback signal 206. The feedback error module 208 receives the feedback signal 206 and compares the feedback signal 206 against a plurality of voltage references, or levels, V_{REF} 210a-x. As can be readily appreciated by those of ordinary skill in the art, the voltage levels V_{REF} 210a through 210x may provided as appropriately adjusted references that are input to the comparators for representing different output voltage compensation levels. Also, the voltage levels Vref 210a through 210x may be implemented as one voltage reference Vref provided to comparators having a fixed input offset to generate level differentiation functionality. Other configurations may be implemented to provide the error estimation between the voltage provided and the voltage requested at the output voltage 204 by a load 223.

The comparison conducted by the feedback error module 208 is according to a set of clock cycles provided by a clock 212. The comparison result between the feedback signal 206 and the voltage references V_{REF} 210a-x is provided by a multi-bit error term 214, which is a digital stream of data having a rate corresponding to the clock 212.

The digital stream of comparison data of the multi-bit error term 214 is provided to the filter module 216. The filter module 216 is generally configured to provide higher frequency noise filtering. The filter module 216 filters the multi-bit error term 214 to produce a digital regulation signal 218. The digital regulation signal 218 may be used to regulate a linear regulator, as well as that a variety of DC-DC converter circuits may be implemented—the DC-DC conversion circuit 200 of FIG. 2 is but one embodiment for achieving the voltage conversion.

For a DC-DC converter, a quantizer 220 is operably coupled to the regulation module 205 to receive the regulation signal 218. The quantizer 220 quantizes the regulation signal 218 to produce a charge signal 222. Generally, quantization operates to divide a continuous range of input signal values provided by the regulation signal 218 into non-overlapping subranges, where each subrange has a corresponding discrete value which in turn is provided through a charge signal 222.

A switching circuit 226 is operably coupled to receive the charge signal 222. As shown, the switching circuit 226 has an n-channel transistor Q_{CHARGE}, a p-channel transistor Q_{LOAD}, and an external element L. The p-channel transistor Q_{LOAD} and the n-channel transistor Q_{CHARGE} are operably coupled to the external element L. The p-channel transistor Q_{LOAD} and the n-channel transistor Q_{CHARGE} couple and decouple the external element L between the power source 224 and the output voltage 204 based upon the charge/load information or data of the charge signal 222.

As shown in FIG. 2, the charge signal 222 provides charge/load data information to the gate inputs of the respective transistors Q_{LOAD} and Q_{CHARGE}. When the charge signal 222 is enabled (or logic “1”), the n-channel transistor Q_{CHARGE} is enabled, while the p-channel transistor Q_{LOAD} is disabled. In this configuration, the external element L is coupled across the power source 224 and thus is receiving a current IL.

When the charge signal 222 is disabled (or logic “0”), the p-channel transistor Q_{LOAD} of the switching circuit is turned on, while the n-channel transistor Q_{CHARGE} of the switching circuit is disabled. In this configuration the external element L is coupled to the output voltage 204 and the load 223, such that the external element L is discharging energy into the load 223. In this manner, the digital DC-DC converter 200 provides a regulated—that is, a substantially constant and steady—operative voltage level available to the components of the IC 100.

In operation, the regulation module 205 senses the output voltage 204 and provides the feedback signal 206 through a controller feedback loop responsive to the voltage and/or current requirements of the load 223. As the power requirements of the load 223 changes or varies, the feedback network 202 senses the output voltage 204, which provides information regarding power requirements via the feedback signal 206. The feedback signal 206 is compared with the voltage reference V_{REF} 210a-x at a predetermined clock rate provided by the clock 212 to produce the multi-bit error term 214.

The filter module 216 receives the multi-bit error term 214, which has a digital stream of data relating to the comparison between the feedback signal 206 and the voltage references V_{REF} 210a-x. The filter module 216 is configured to provide higher frequency noise filtering, and indicates the duty cycle of the p-channel transistor Q_{LOAD} of the switching circuit 226. As is known to those of ordinary skill in the art, the filter module 216 may be provided as an integrator circuit having an output operably coupled to a linearizer circuit, as well as other filter configurations, such as a resistor-capacitor series configuration operating as a loop filter.

The quantizer 220 is operable to quantize the regulation signal 218 to produce the charge signal 222, which is a digital stream of charged data and load data for the operation of the switching circuit 226. The charge signal 222 contains a digital stream of charge data and load data to the switching circuit 226 the load/charge durations external element L. Generally, the ratio between load duration and the charge duration for the external element L is digitally encoded and the charge signal 222 will increase if the output of the multi-bit comparator provided through the feedback error module 208 is at a high state more than 50% of the time. Similarly, the ratio between the load duration and the charge duration is digitally encoded and the charge signal 222 will decrease if the output of the feedback error module 208 is high less than 50% of the time.

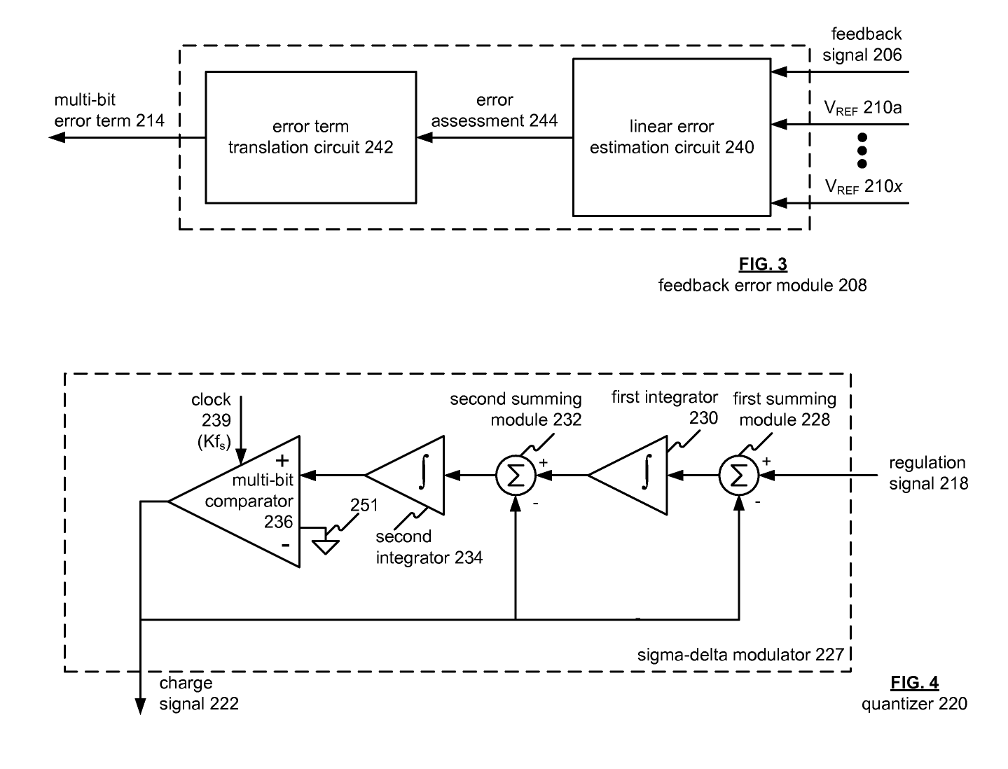

FIG. 3 illustrates a schematic block diagram of the feedback error module 208. The feedback error module 208 has a linear error estimation circuit 240 and an error term translation circuit 242.

The linear error estimation circuit 240 is operably coupled to compare the feedback signal 206 with a plurality of reference levels 210a through 210x to produce an error assessment 244. The reference levels V_{REF} 210a through 210x represent the power requirement variation expected or anticipated at the output voltage 204 (see FIG. 2).

For example, referring briefly to FIG. 1, the power consumption between the input/output devices provided to the I/O pin multiplexer 110 will generally vary within a 0.5 watt range, such as with the LED/LCD buttons, memory access, and the like. But other components incur large power consumption spikes with respect to other components within the system-on-chip 100. An example of such a component is a hard drive, which may be provided as a micro-miniature hard drive to increase the storage capacity of a hand-held device implementing an IC 100. Operation of the miniature motors of the micro-miniature hard drive consequently tasks a regulation module to deliver a relatively large amount of current on short notice. For example, a 30-GByte drive with a 1.8-inch platter and a 15-millisecond seek time may need 1.3 watts with a 480 mA draw on startup. For comparison, such devices may need 0.23 watts for standby operation. Accordingly, the reference levels V_{REF} 210a through 210x are selected to differentiate between disparate device power requirements of the IC 100.

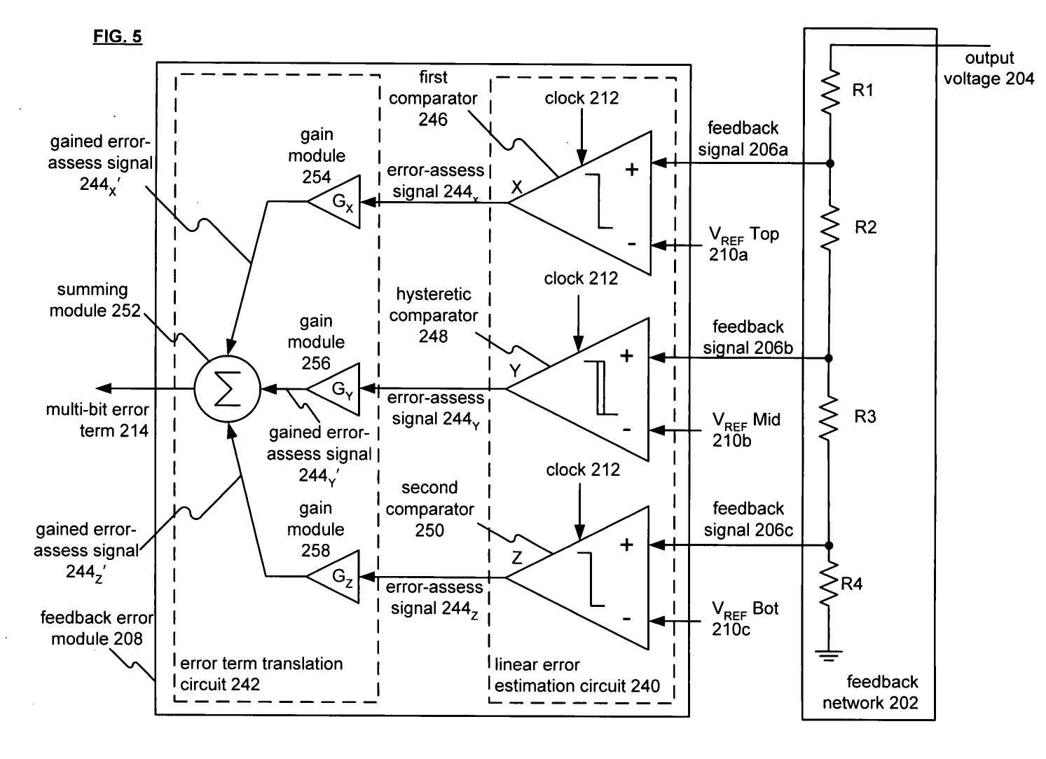

The voltage references V_{REF} 210a through 210x may be implemented using a band gap reference of the IC 100. A suitable bandgap reference may be provided through use of a Brokaw Cell or may be constructed in accordance with the teaching of U.S. Pat. No. 6,859,156, issued Feb. 22, 2005, and titled VARIABLE BANDGAP REFERENCE AND APPLICATIONS THEREOF, which is hereby incorporated by reference. The voltage references V_{REF} 210a through 210x will be described in greater detail with reference to FIG. 5.

The error term translation circuit 242 is operably coupled to translate the error assessment 244 to produce a multi-bit error term 214. The error term translation circuit 242 contains response or drive circuitry to provide sufficient response capability to the needs of the load 223 (see FIG. 2). As discussed, devices such as micro-miniature hard drives require a relatively large amount of current on short notice. The error term translation circuit 242 will be described in greater detail with reference to FIG. 5.

FIG. 4 illustrates a schematic block diagram of a quantizer 220. As shown, the quantizer 220 is implemented as a second-order sigma-delta modulator having a first summing module 228, a first integrator 230, a second summing module 232, a second integrator 234, and a multi-bit comparator 236.

The multi-bit error term 214 is operably coupled to the first input of the first summing module 228. An output of the summing module 228 is operably coupled to the first integrator 230 which in turn, is operably coupled to the second summing module 232. The second integrator 234 is operably coupled via its output to the multi-bit comparator 236. The multi-bit comparator 236 is operably coupled to sense the output of the second integrator 234 to compare it with a reference level 251. The reference voltage 251 is shown in FIG. 4 as a digital ground. The multi-bit comparator 236 compares the output of the second integrator 234 with a reference voltage to produce k-bits at a predetermined clock rate of Kfₛ provided by the clock 239, where “K” is a constant value selected to provide a clock rate that substantially corresponds to the data rate associated with the digital regulation signal 214. The output of the multi-bit comparator 236 is operably coupled to the subsequent inputs of the first summing module 228 and a second input of the second summing module 232, accordingly.

As discussed, the quantizer 220, through use of the second order sigma-delta modulator, is operably coupled to quantize the regulation signal 218 to produce the charge signal 222. In operation, the data provided by the regulation signal 218 is summed at the first summing module 228 with the multi-bit output of the feedback from multi-bit comparator 236. The output of the first summing module 228 is provided to the first integrator 230, which adds the output of the first summing module 228 to a value that the first integrator has stored from a previous integration step. The output of the first integrator 230 is provided to the second summing module 232 with the multi-bit output of the multi-bit comparator 236. The output of the second summing module 232 is provided to the second integrator 234, which adds the output of the second summing module 232 to a value that the second integrator 234 has stored from a previous integration step. The output of the second integrator 234 is provided to the multi-bit comparator 236. The comparator 236 compares the output of the second integrator 234 with the reference voltage 251 at a predetermined clock rate Kfₛ provided by the clock 239, where K is a coefficient selected to provide a clock rate that substantially corresponds to the data rate associated with the digital regulation signal 214. It should be readily appreciated, however, that other values of K may be selected so as to provide other sampling rates, such as oversampling, with respect the data rate of the digital regulation signal 214.

As shown, the output of the multi-bit comparator 236 is fed into the summing modules 232 and 228. The quantizer 220 can be provided by other circuitry, such as truncation or round-end circuitry. But by using a sigma-delta modulator architecture, noise from the quantization is pushed to a higher frequency to be filtered out by a capacitance associated with the load 223 (see FIG. 2).

FIG. 5 illustrates the feedback error module 208 and the feedback network 202 in greater detail. The feedback error module 208 provides for the capability to determine the degree of deviation at the output voltage 204 (see FIG. 2) and to compensate the power requirement at the output voltage 204, accordingly. In other words, the feedback error module 208 is configured to sufficiently respond with a relatively large amount of current on short notice.

As shown, the feedback network 202 includes a resistive divider network having resistive elements R1, R2, R3, and R4 arranged as a resistive divider with multiple paths between the resistive elements. Accordingly, provided through the resistive paths, via a plurality taps, are feedback signal 206a, feedback signal 206b and feedback signal 206c, which constitute the feedback signal 206 shown in FIG. 2.

The feedback error module 208 has a linear error estimation circuit 240 and an error term translation circuit 242. The linear estimation circuit 240, as shown, has three comparators 246, 248, and 250, having a plurality of voltage references V_{REF} Top 210a, V_{REF} Mid 210b, and V_{REF} Bot 210c, respectively.

The comparator 246 is operably coupled to receive the feedback signal 206a for comparison with a voltage reference V_{REF} Top 210a to produce an error-assess signal 244_{Z}. The voltage reference V_{REF} Top 210a refers to an upper level voltage limit of the DC-to-DC converter 200.

The comparator 248 is operably coupled to receive the feedback signal 206b for comparison with a voltage V_{REF} Mid 210b to produce an error-assess signal 244y. The voltage reference V_{REF} Mid 210b refers to a mid-range level voltage limit of the digital DC-DC converter 200.

The comparator 250 is operably coupled to receive a feedback signal 206c, which is compared to a voltage V_{REF} Bot 210c to produce an error-assess signal 244_{Z}. The voltage reference V_{REF} Bot 210c refers to a lower level voltage limit for the DC-to-DC converter 200.

The linear error estimation circuit 240 is configured to sense and estimate the amount of error between the voltage provided and the voltage requested at the output voltage 204 by a load 223 (see FIG. 2).

In the power consumption profile of devices such as a micro-miniature hard drive, there is roughly a five-second period in which the power consumption will rise to 1.5 watts as a song in digitally formatted audio, or other form of audiovisual media, is accessed for play from the hard disk. During the playback, the power consumption drops to about 0.4 or 0.2 watts, depending on whether other components within the device are maintained as being on, such as a back light for the LED display, while the song or other form of audiovisual media is playing.

Generally, power requirements will rise and fall within a 0.5-watt range, depending upon the application of the devices per field input, such as click wheels and display touchpads. The hysteretic comparator 248 has sufficient levels provided by the voltage reference V_{REF} Mid 210b to allow the DC-DC converter 200 to compensate for these power requirements. But for larger power consumption and response requirements of devices such as a micro-miniature hard drive, suitable assessment is provided with the first comparator 246 and voltage reference V_{REF} Top 210a, and the second comparator 250 and voltage reference V_{REF} Bot 210c.

The first comparator 246 and the second comparator 250 provide an error-assess signal 244_{X} and 244_{Z}, respectively. The error-assess signals 244x, 244y, and 244z provided by the linear error estimation circuit 240 is illustrated by the following table:

| State | X | Y | Z | Error Estimation |
|---|---|---|---|---|
| A | L | L | L | +Large Correction |
| B | L | L | H | +Small Correction |
| C | L | T | H | No Correction |
| D | L | H | H | −Small Correction |
| E | H | H | H | −Large Correction |

The “State” field, having states A through E, indicates the operational state the DC-DC converter 200. The fields “X”, “Y”, and “Z” indicate the output of the error-assess signal 244X, 244Y, and 244Z, respectively. The values of the fields X, Y, and Z are low (L), high (H), and toggle (T). The “Error Estimation” field indicates the level of error correction needed to provide to the output voltage 204 (see FIG. 2), which is either a positive (+) large correction, a positive (+) small correction, no correction, a negative (−) small correction, or a negative (−) large correction.

The error term translation circuit 242 is operably coupled to receive the error-assess signals 244x, 244y, and 244z. Each of the error-assess signals are provided to respective gain modules 254, 256, and 258. The gain modules 254, 256, and 258 have associated gains of G_{X}, G_{Y}, and G_{Z}, accordingly. The gain levels associated with the respective gain modules provide the translation or correction magnitude with the amount of power correction to provide at the output voltage 204. That is, the gains G_{X}, G_{Y}, and G_{Z} are determined with respect to the magnitude of the step for adjustment purposes. For example, for compensating for a large amount of current, a large gain level is used. The gain modules 254, 256, and 258 provide as outputs gained error-assess signal 244_{X}′, 244_{Y}′, and 244_{Z}′, respectively. The gain error-assess signals 244_{X}′, 244_{Y}′, and 244_{Z}′ prime are provided to a summing module 252. The summing module 252 provides as an output the multi-bit error term 214 conveying a digital stream of data with respect to the associated gains provided by the error term translation circuit 242. Through the gain modules 254, 256, and 258 of the error term translation circuit 242, the capability of adjusting and compensating for current spikes or other large power requirement shifts is provided.

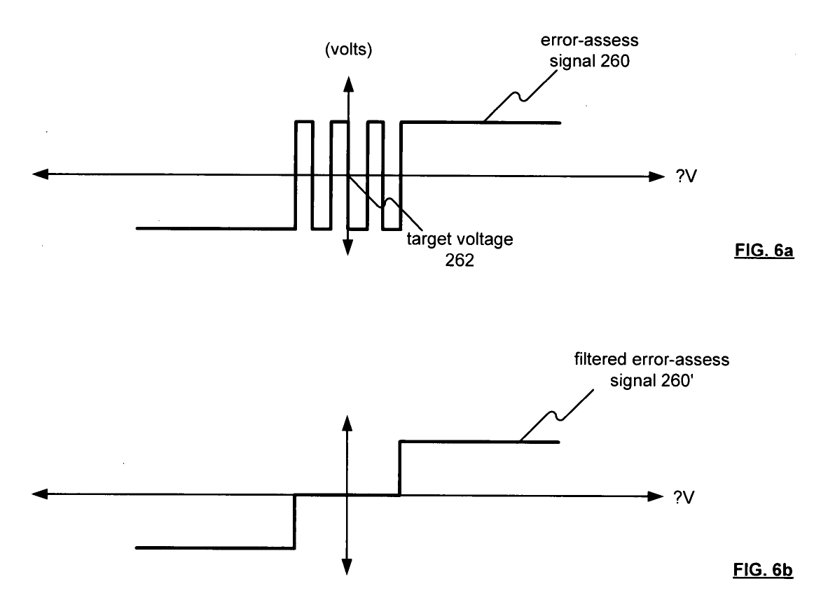

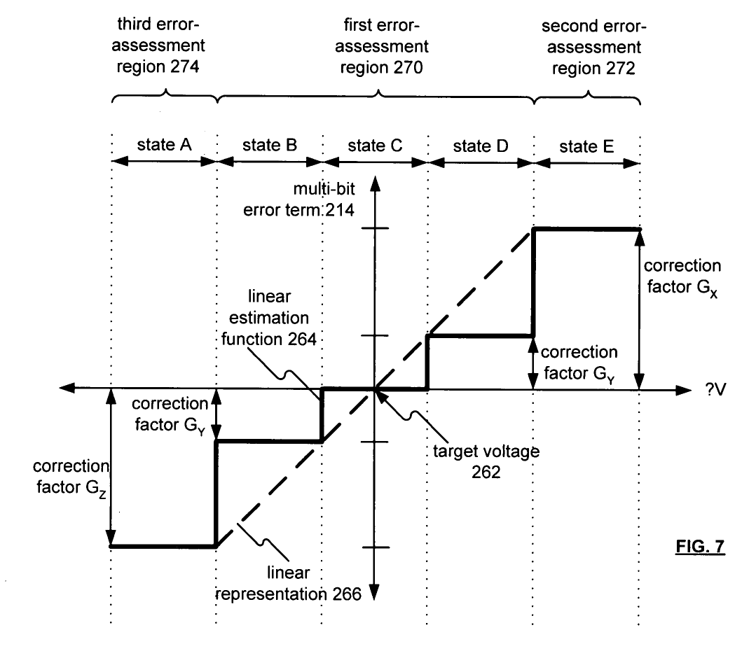

FIG. 6a is a graph of an error assessment output versus the input voltage of the hysteretic comparator 248. Shown is a target voltage 262 defined as the intersection between the x-axis and the matching of the output voltage 204. Plotted line 260 is the output characteristic of the hysteretic comparator 248, or error assess signal 244b, responsive to the differential between the inputs to the hysteretic comparator 248. As value of the feedback signal 206b of FIG. 5 approaches the voltage reference V_{REF} 210b, which coincides with the target voltage 262, and the differential diminishes, the characteristic of the hysteretic comparator is to toggle or oscillate the output 260, which is the error-assess signal 244_{Y}.

FIG. 6b is a graph of the regulation signal 218 with respect to the input voltage of the hysteretic comparator 248, that reflects the error-assess component of the hysteretic comparator 248 filtered by the filter module 216 (see FIG. 2), plotted as line 260′. The effect of the oscillation is to simplify the circuitry for the feedback error module 208 by filtering out the mid-range as the output voltage 204 approaches the target voltage 262, indicating that for normal operation no correction is needed. As noted earlier, the filter module 216 is a low-pass configuration. Accordingly, as the output voltage 204 approaches the target voltage 262, a flat level response results for maintaining the present voltage level required by the output voltage 204.

FIG. 7 is a multi-bit error term versus the output voltage 204 illustrating a linear error estimation function 264 of the digital DC-DC converter 200. As shown in FIG. 7, and discussed with respect to FIG. 5, the power adjustment regions are provided as state A, state B, state C, state D, and state E.

The states A, B, C, D, and E are further grouped into error-assessment regions 270, 272, and 274. The first error-assessment region 270 contains state B, C, and D. The first error-assessment region 270 represents a general, or normal, operational mode of the IC 100 in that the load power requirements are generally rising and falling within a normal operational range, such as a 0.5-watt range.

The second error-assessment region 272 contains state E. The third error-assessment region 274 contains state A. Each of these regions represent a power requirement change by the load 223, such as when there is a need to deliver a relatively large amount of current on short notice to a micro-miniature hard drive.

State A denotes a region where a large negative correction is required, where magnitude of correction is represented as the gain or correction factor G_{Z} provided by the gain module 258 (see FIG. 5). State B denotes a region where a small negative correction is required, where the magnitude of correction is represented as the gain or correction factor G_{Y} provided by the gain module 256 (see FIG. 5). State C denotes a region where no correction is required, and accordingly, no gain or correction factor is associated with state C. State D denotes a region where a small positive correction is required, where the magnitude of correction is represented as the gain or correction factor G_{Y} provided by the gain module 256. State E denotes a region where a large positive correction is required, where magnitude of correction is represented as the gain or correction factor G_{X} provided by the gain module 254 (see FIG. 5).

As shown in FIG. 7, the gain or correction factors G_{X} and G_{Z} are greater than the gain or correction factor G_{Y}. Accordingly, the suitable gain factors G_{X} and G_{Z} are selected to provide for sufficient transient response for loads and corresponding power provisioning to the output voltage 204, such as those loads involving micro-miniature hard drives.

In FIG. 7, as the difference increases between the output voltage 204 and the load 223 requirements, that is, ΔV, the larger the amount of correction or compensation is needed to return to the target voltage 262. Referring briefly to FIG. 2, the regulation module 205, through a DC-DC converter 200, provides a a multi-bit error term 214, which is consequently provided through a filter module 216 to produce a regulation signal 218. The regulation signal 218 is processed by the quantizer 220 and conveyed as a charge signal 222 that provides the correction factors G_{Z}, G_{Y} and G_{X} through the linear error estimation function 264.

As shown in FIG. 7, the linear error estimation function 264 represents a linear error approximation with respect to deviations or change as present at the output voltage 204. Furthermore, referring briefly to FIG. 5, the gain modules 254, 256 and 258 of the error term translation circuit 242, the gain or correction factors G_{X}, G_{Y}, and G_{Z}, respectively, are provided via the charge signal 222 to the switching circuit 226 with appropriate charge/load cycle information responsive to the correction factors. As shown, the linear estimation function 264 provides coarse granularity; however, the nature of the estimation function 264 is linear in nature, as shown by the dashed line of linear representation 266. In this manner, the error assess signals 244x, 244y, and 244z are representative of a linear estimation function 264. As can be readily appreciated, further definition and finer granularity can be provided to the linear estimation function 264 by the increasing the number of comparators with respect to further operational levels of an IC 100 as needed or as desired.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level and/or voltage level. As one of average skill in the art will also appreciate, inferred coupling (that is, where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that a first signal has a greater magnitude than a second signal, a favorable comparison may be achieved when the magnitude of the first signal is greater than that of the second signal or when the magnitude of the second signal is less than that of the first signal. While the transistors or switches in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), n-well transistors, p-well transistors, enhancement mode, depletion mode, and zero voltage threshold (VT) transistors.

The preceding discussion has presented a method and apparatus for a DC-DC regulator having an increased transient response in providing correction factors to compensate for large changes in the power requirements of a load. In general, this is achieved by a feedback error module operably coupled to compare a sensed output voltage with a voltage reference to generate a multi-bit error term representative of the change in a load requirements.

1. A digital regulation module comprises:
a feedback network operably coupled to an output voltage to provide a feedback signal;
a feedback error module operably coupled to compare the feedback signal with a plurality of reference levels to produce a multi-bit error term; and
a filter module operably coupled to filter the multi-bit error term to produce a regulation signal.

2. The digital regulation module of claim 1 wherein the feedback error module further comprises:
linear error-estimation circuitry operably coupled to compare the feedback signal with the plurality of reference levels to produce a plurality of error-assess signals; and
error term translation circuitry operably coupled to translate the plurality of error-assess signals into the multi-bit error term.

3. The digital regulation module of claim 2 wherein the linear error-estimation circuitry further comprises:
a hysteretic comparator operably coupled to compare the feedback signal with a mid-reference level at a predetermined clock rate to produce a first error-assess signal of the plurality of error-assess signals;
a first comparator operably coupled to compare the feedback signal with a top-reference level at the predetermined clock rate to produce a second error-assess signal of the plurality of error-assess signals; and
a second comparator operably coupled to compare the feedback signal with a bottom-reference level at the predetermined clock rate to produce a third error-assess signal of the plurality of error-assess signals.

4. The digital regulation module of claim 3 wherein the error term translation circuitry further comprises:
a first gain module operably coupled to amplify the first error-assess signal to produce a first gained assess signal;
a second gain module operably coupled to amplify the second error-assess signal to produce a second gained assess signal;
a third gain module operably coupled to amplify the third error-assess signal to produce a third gained assess signal; and
a summing module operably coupled to sum the first gained error-assess signal, the second gained error-assess signal, and the third gained error-assess signal to produce the multi-bit error term.

5. A digital DC-DC converter comprises:
a feedback network operably coupled to an output of the digital DC-DC converter to provide a feedback signal;
a feedback error module operably coupled to compare the feedback signal with a plurality of reference levels to produce a multi-bit error term;
a filter module operably coupled to filter the multi-bit error term to produce a regulation signal;
a quantizer module operably coupled to quantize the regulation signal to produce at least a charge signal; and
a switching circuit operably coupled to receive the charge signal, wherein the switching circuit couples an external element to a source for charging in accordance with the charge signal and couples the external element to a load in accordance with the charge signal.

6. The digital DC-DC converter of claim 5 wherein the feedback error module further comprises:
linear error-estimation circuitry operably coupled to compare the feedback signal with the plurality of reference levels to produce a plurality of error-assess signals; and
error term translation circuitry operably coupled to translate the plurality of error-assess signals into the multi-bit error term.

7. The digital DC-DC converter of claim 6 wherein the linear error-estimation circuitry further comprises:
a hysteretic comparator operably coupled to compare the feedback signal with a mid-reference level at a predetermined clock rate to produce a first error-assess signal of the plurality of error-assess signals;
a first comparator operably coupled to compare the feedback signal with a top-reference level at the predetermined clock rate to produce a second error-assess signal of the plurality of error-assess signals; and
a second comparator operably coupled to compare the feedback signal with a bottom-reference level at the predetermined clock rate to produce a third error-assess signal of the plurality of error-assess signals.

8. The digital DC-DC converter of claim 7 wherein the error term translation circuitry further comprises:
a first gain module operably coupled to amplify the first error-assess signal to produce a first gained assess signal;
a second gain module operably coupled to amplify the second error-assess signal to produce a second gained assess signal;
a third gain module operably coupled to amplify the third error-assess signal to produce a third gained assess signal; and
a summing module operably coupled to sum the first gained error-assess signal, the second gained error-assess signal, and the third gained error-assess signal to produce the multi-bit error term.

9. The digital DC-DC converter of claim 5, wherein the switching circuit comprises:
a first switch operable to couple the external element to the source for charging in accordance with the charge signal; and
a second switch operable to couple the external element to the load in accordance with the charge signal when the output voltage is to be charged during a given set of clock cycles.

10. The digital DC-DC converter of claim 5 wherein the feedback network is a resistive divider network having a plurality of taps.

11. The digital DC-DC converter of claim 5 wherein the quantization module is a sigma-delta modulator.

12. A comprehensive system-on-a-chip comprises:
a processing core operably coupled to process input digital data and produce therefrom output digital data;
digital interface circuitry operable coupled to provide the input digital data to the processing core and to receive the output digital data from the processing core;
mixed signal circuitry operably coupled to convert input analog signals into the input digital data and to convert the output digital data into output analog signals; and
digital DC-DC converter circuitry operably coupled to convert a source voltage into a supply voltage that supplies at least one of: the processing core, the digital interface circuitry, and the mixed signal circuitry, wherein the digital DC-DC converter circuitry includes:
a feedback network operably coupled to an output of a DC-DC converter to provide a feedback signal;
a feedback error module operably coupled to compare the feedback signal with a plurality of reference levels to produce a multi-bit error term;
a filter module operably coupled to filter the multi-bit error term to produce a regulation signal;
a quantizer module operably coupled to quantize the regulation signal to produce at least a charge signal; and
a switching circuit operably coupled to receive the charge signal, wherein the switching circuit couples an external element to the source voltage for charging in accordance with the charge signal and couples the external element to a load in accordance with the charge signal.

13. The comprehensive system-on-a-chip of claim 12 wherein the feedback error module further comprises:
linear error-estimation circuitry operably coupled to compare the feedback signal with the plurality of reference levels to produce a plurality of error-assess signals; and
error term translation circuitry operably coupled to translate the plurality of error-assess signals into the multi-bit error term.

14. The comprehensive system-on-a-chip of claim 13 wherein the linear error estimation circuitry further comprises:
a hysteretic comparator operably coupled to compare the feedback signal with a first reference level of the plurality of reference levels at a predetermined clock rate to produce a first error-assess signal of the plurality of error-assess signals;
a first comparator operably coupled to compare the feedback signal with the second reference level at the predetermined clock rate to produce a second error-assess signal of the plurality of error-assess signals; and
a second comparator operably coupled to compare the feedback signal with the reference level at the predetermined clock rate to produce a third error-assess signal of the plurality of error-assess signals.

15. The comprehensive system-on-a-chip of claim 14 wherein the error term translation circuit further comprises:
a first gain module operably coupled to amplify the first error-assess signal to produce a first gained assess signal;
a second gain module operably coupled to amplify the second error-assess signal to produce a second gained assess signal;
a third gain module operably coupled to amplify the third error-assess signal to produce a third gained assess signal; and
a summing module operably coupled to sum the first gained error-assess signal, the second gained error-assess signal, and the third gained error-assess signal to produce the multi-bit error term.

16. The comprehensive system-on-a-chip of claim 12, wherein the switching circuit comprises:
a first switch operable to couple the external element to the source for charging in accordance with the charge signal; and
a second switch operable to couple the external element to the load in accordance with the charge signal when the output voltage is to be charged during the given set of clock cycles.

17. The comprehensive system-on-a-chip of claim 12 wherein the feedback network is a resistive divider network having a plurality of taps.

18. The comprehensive system-on-a-chip of claim 12 wherein the quantization module is a sigma-delta modulator.

19. A method for regulating an output voltage of a DC-DC converter comprises:
comparing a feedback signal representation of the output voltage with a plurality of reference voltages to produce a multi-bit error term;
filtering the multi-bit error term to produce a regulation signal of charge data and load data;
quantizing the regulation signal of charge data and load data to produce a charge signal having a charge component and a load component;
during a given set of clock cycles, enabling charging of an external element in accordance with the charge component of the charge signal; and
during the given set of clock cycles, enabling discharging of the external element to a load in accordance with the load component of the charge signal.

20. The method of claim 19 wherein the comparing a feedback signal further comprises:
comparing the feedback signal with a plurality of reference levels to produce a multi-level error-assessment; and
translating the multi-level error-assessment into the multi-bit error term.

21. The method of claim 20 wherein the comparing the feedback signal with a plurality of reference levels to produce a multi-level error-assessment further comprises:
comparing the feedback signal with the plurality of reference levels at a predetermined clock rate to produce a plurality of error-assessments that are representative of a linearized error-assessment.

22. The method of claim 21 wherein the translating the multi-level error-assessment further comprises:
amplifying each error-assessment of the plurality of error-assessments to produce a plurality of gained assessments; and
summing the plurality of gained assessments to produce the multi-bit error term.

23. The method of claim 19 wherein quantizing the regulation signal of charge data and load data to produce a charge signal having a charge component and a load component is performed by a sigma-delta modulator.
